(19) United States
(12) Patent Application Publication
(10) Pub. No.: US 2013/0057020 A1
(43) Pub. Date: Mar. 7, 2013

(54) BOX TRUCK AND TRAILER TURBULENCE REDUCING DEVICE

(71) Applicant: Leo L. Burrell, Honolulu, HI (US)

(72) Inventor: Leo L. Burrell, Honolulu, HI (US)

(21) Appl. No.: 13/224,278

(22) Filed: Sep. 1, 2011

(51) Int. Cl. B62D 35/00

(52) U.S. Cl. 296/180.2

(57) ABSTRACT

This invention relates to devices that reduce the drag against the rear end of Box Trucks and Trailers caused by turbulent airflow over, under, and from the sides of said vehicles while moving. This invention uses the compression of the plurality of vortices within the turbulence chamber to create an entropic relationship with ensuing vortices flowing over the open top and bottom of the chamber-causing those turbulent air vortices to flow over the chamber. This entropic “order out of disorder” effect eliminates the need for a top or bottom physical skin (sheet metal, plastic, etc.) to close the chamber.

### REFERENCES

| | | |
|---|---|---|
| U.S. Pat. No. 7,740,304 B1 | Jun. 22, 2010 | Thomas James Breu |
| U.S. Pat. No. 6,959,958 B2 | Nov. 01, 2005 | William C. Basford |
| U.S. Pat. No. 7,380,868 B2 | Jun. 03, 2008 | Thomas Scott Breidenbach |
| U.S. Pat. No. 6,595,578 B1 | Jul. 22, 2003 | Kyril Calsoyds |
| U.S. Pat. No. 6,409,252 B1 | Jun. 25, 2002 | Paul Guy Andrus |
| U.S. Pat. No. 6,309,010 B1 | Oct. 30, 2001 | W. David Whitten |
| U.S. Pat. No. 6,092,861 | Jul. 25, 2000 | William Whelan |
| U.S. Pat. No. 5,823,610 | Oct. 20, 1998 | William J. Ryan |
| U.S. Pat. No. 4,978,162 | Dec. 18, 1990 | Francois P. Labbe |

### BACKGROUND OF THE INVENTION

This invention relates to devices which dispose box truck's and semi trailer's rearward edges in more aerodynamic shapes using various metal, plastic, and fabric attachments so as to reduce the drag operating against the back edge of said vehicles caused by turbulent air flowing over, under, and at the sides of them.

In researching prior art I discovered several devices that are nominally effective in reducing drag. The time it takes to set-up and take-down these devices reduces the effective gain from fuel savings. The cost; profit ratio, and driver resistance to using them has kept the trucking industry from trying them. There is an arbitrary 53 ft. limit for trailer length that seems to have been determined by turning radius at city street corners, and is unfairly applied to commercial vehicles operating substantially on interstate highways. Reason suggests that longer trailers can operate safely on highways, but length is length, and it doesn't matter that an effective drag reducing appurtenance can be closed while the trailer is deployed in the city. A variance from the length rule is suggested for highway use. The present design obviously extends the overall shape of a trailer beyond the 53 ft. limit of trailers that are already stretched to the limit. It should matter that this particular design is shaped such that no part of it would adversely affect the turning radius of it. But then, most shapes of this art extend the length of the truck or trailer. It would be impossible to reduce drag without extending the box shape in one manner or another. The 53 ft. rule is mutually exclusive when examined by the paradigm of legal length. Some of the designs seem to be somewhat effective but cause long delays and require substantial lay-down facilities for the devices when backing into a loading dock.

### BRIEF DESCRIPTION OF THE DRAWINGS

FIG. 1 is a partial view of a Box Truck or Trailer showing the 2-part slideable false door stowed at the side of the body with the actuators withdrawn.

FIG. 2 is a view of the same appurtenance deployed. No latch is anticipated to hold the trailing edges of the rear panels together. The actuators are adjusted to close the panels and turbulent air flowing over the outside surface tends to support closure.

FIG. 3 is a view of the stops—pins attached near the upper and lower corners of the body which act to stop movement of the forward panel—causing the continued force of the actuators to rotate the rear panel inwardly.

FIG. 4 is a view showing bearings in the upper and lower tracks and the position of the stops engaging the forward panel. The rear panel slides in the track but the upper edge is below the upper stop and the lower edge is above the lower stop.

### SUMMARY OF THE INVENTION

Accordingly a few objects of my invention are as follows: The primary object of my invention is to provide a more aerodynamic box truck or semi trailer rearward shape that reduces the drag against its blunt end caused by turbulent flow of air from top, bottom, and sides of the vehicle.

It is an object of my invention to provide an appurtenance to a truck or trailer that can be manipulated easily and quickly by one person both to deploy and to restore it to its stowage tracks while in motion on the highway using cab-mounted controls to engage electro-pneumatic actuators to extend or retract the slideable false doors.

It is an object of my invention to provide an appurtenance to a truck or trailer that is made of common light-weight materials that do not require expensive operations to manufacture and are cost effective. It is an object of my invention to provide an appurtenance to a truck or trailer that can be deployed or stowed quickly and easily so that approaching and exiting a loading dock doesn't consume time or space that would limit its effective or efficient use.

### DETAILED DESCRIPTION OF THE INVENTION

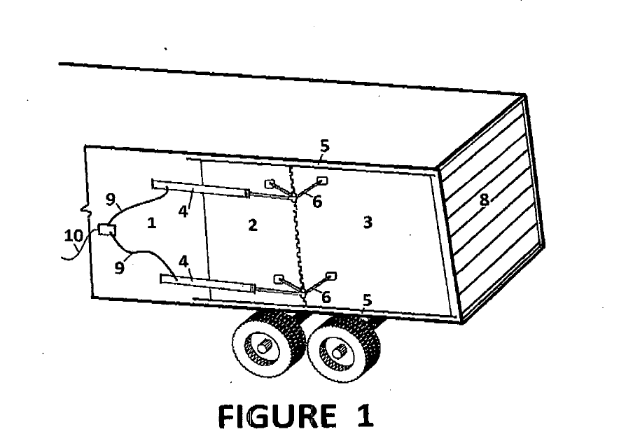

FIG. 1 is a perspective of the invention wherein the body of a truck or trailer 1 has been modified to support slideable false door panel 2 hinged 12 to door panel 3 as they would appear when not deployed. The false door panels 2 & 3 are fully contained in the upper and lower tracks 5. Electro-pneumatic actuators 4 are connected to rotatable knee-joints, and fully retracted. Power for the actuators is supplied by electrical means via cables 9 and/or junction boxes 10, and manipulated by an operator in the cab of said truck or tractor. A sliding door 8 is disposed in this view but hinged box truck or trailer doors are also anticipated in this invention.

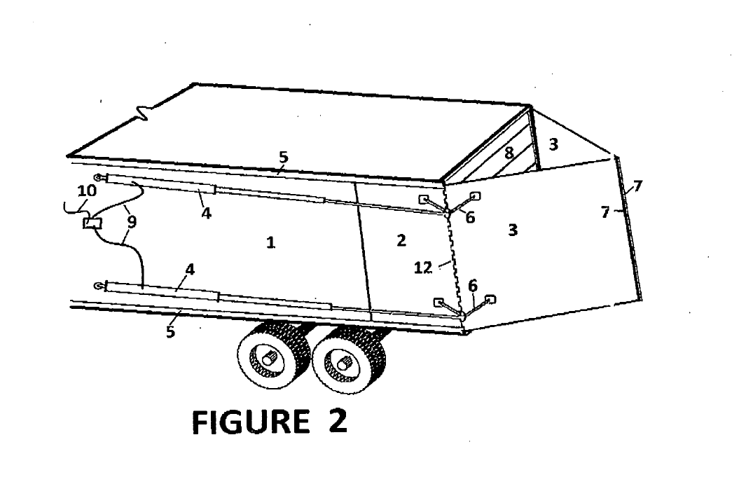

FIG. 2 is a perspective of the left side panel arrangement wherein the door panels 2 & 3 slide in tracks 5 having bearings 13 to make deployment easier. While linear actuators 4 are shown as the preferred embodiment of the invention, light-weight panels are also anticipated that can be manipulated by hand or other means—such other means not limiting the invention to the preferred embodiment. The right-hand tracks, doors, etc. for the right side of the truck operate in the same manner which, when fully extended together with the left panel arrangement, forms a closing joint 7 that forms the turbulence chamber between the blunt box body 1 and panels 3 (left) and 3 (right).

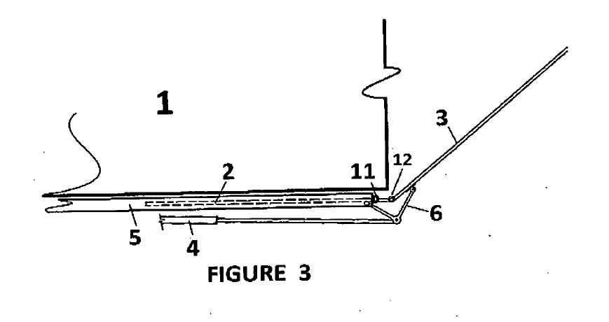

FIG. 3 is an expanded view of the corner of a blunt truck or trailer body showing a detail view of the stop 11, hinge 12, and the knee-joint 6 as they would be configured when deployed.

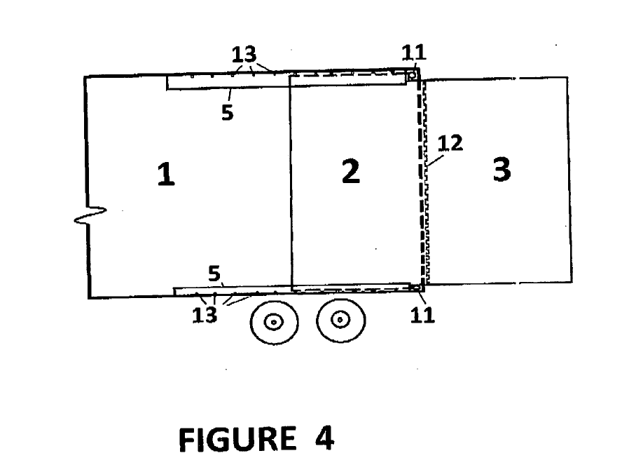

FIG. 4 is a view showing the forward slideable panel 2 fully contained in the tracks 5 and against stops 11. Slideable panel 3—which is disposed in the tracks 5 when not deployed move freely below upper stop 11 and above lower stop 11. Panels 3 do not bear on the bearings 12 in the tracks 5 in this drawing but other means of securing them rigidly against gravitation and rotation forces while stored are anticipated. Such means may be separate tracks for panels 2 and 3 and this view is not intended to limit the invention to this means.

What I claim is:

1. A device for creating a turbulence chamber rearward of Box Trucks or Semi Trailers using slideable false doors that hinge at the corner edges of said vehicles and are closeable beyond the rear of said vehicles.

2. Slideable false doors of claim 1 wherein said doors are contained on upper and lower tracks affixed to the side of said vehicle the false doors are not deployed.

3. False doors of claim 1 that when deployed create a turbulence chamber in the shape of a triangle at the back of the truck or trailer.

4. False doors of claim 1 wherein said doors are of various lengths to satisfy safety and regulatory concerns while of sufficient length to create a three dimensional chamber when deployed.

5. Tracks of claim 2 wherein bearings are used on the bottom and top tracks to permit smoother operation of the false doors.

6. False doors of claim 1 wherein the forward facing hinged portion remains in the tracks when the doors are deployed.

7. False doors of claim 6 wherein the forward hinged portion is of sufficient length as to offset the tendency of rotation forces to cause the doors to droop as they are slid rearward for deployment.

8. False doors of claim 1 wherein the doors may be various gauges of metal or plastic, thickened at the edges to limit bending, cracking, or breaking.

9. A device of claim 1 wherein no closing appurtenance is indicated to close the top and bottom of said turbulence chamber. The turbulence generated in the chamber is sufficient to create an entropy wherein the disorganized (turbulent) air in the chamber organizes the turbulent air passing over it in a frictionless motion.

10. A device of claim 1 wherein said false doors are deployed using electro-pneumatic actuators operated by the driver of the vehicle while seated in the cab of the truck or tractor.
